(19) United States
(12) Patent Application Publication
(10) Pub. No.: US 2008/0011236 A1
(43) Pub. Date: Jan. 17, 2008

(54) Bug trap pet bowl

(76) Inventor: Robert Paez, La Puente, CA (US)

Correspondence Address: CHRISTIE, PARKER & HALE, LLP, PO BOX 7068, PASADENA, CA, 91109-7068, US

(21) Appl. No.: 11/488,208

(22) Filed: Jul. 17, 2006

(51) Int. Cl. A01K 5/01

(52) U.S. Cl. 119/61.53

(57) ABSTRACT

A pet bowl that helps keeps insects or bugs out of the contents of the bowl is disclosed. The pet bowl comprises an upper bowl portion, a lower base portion, a pedestal extending between and supporting the bowl portion above the base portion, and a sticky surface on the pedestal.

### BACKGROUND

The present invention is directed to a pet bowl that helps keep insects or bugs out of the contents of the pet bowl.

Pet bowls containing food or water are often placed on the floor or ground to allow easy access by pets. However, crawling insects or bugs, particularly ants, are often attracted to the food or water inside the bowl and enter into the area around the bowls as well as into and on the bowls themselves. The presences of the insects or bugs is an annoyance to both the pets and to their owners. Placing or spraying bug poison around pet bowls can be dangerous to the health of pets or others handling the bowls. Incorporating bug deterrents into a bowl can make it difficult to handle and/or wash the bowls. Accordingly, a need exists for a pet bowl that in one or more embodiments can safely and conveniently deter bugs.

### SUMMARY

One or more embodiments of the present invention provide a pet bowl comprising: an upper bowl portion; a lower base portion; a pedestal extending between and supporting the bowl portion above the base portion; and a sticky surface on the pedestal. The upper bowl portion may also be removably attached to the pedestal. The sticky surface may also be renewable or replaceable.

### BRIEF DESCRIPTION OF THE DRAWINGS

FIG. 1 shows a perspective view of a pet bowl according to one embodiment of the present invention;

FIG. 2 shows a perspective view of a base portion of the pet bowl of FIG. 1;

FIG. 3 shows a side, disassembled view of the pet bowl of FIG. 1; and

FIG. 4 shows a top view of the pet bowl of FIG. 1.

### DETAILED DESCRIPTION

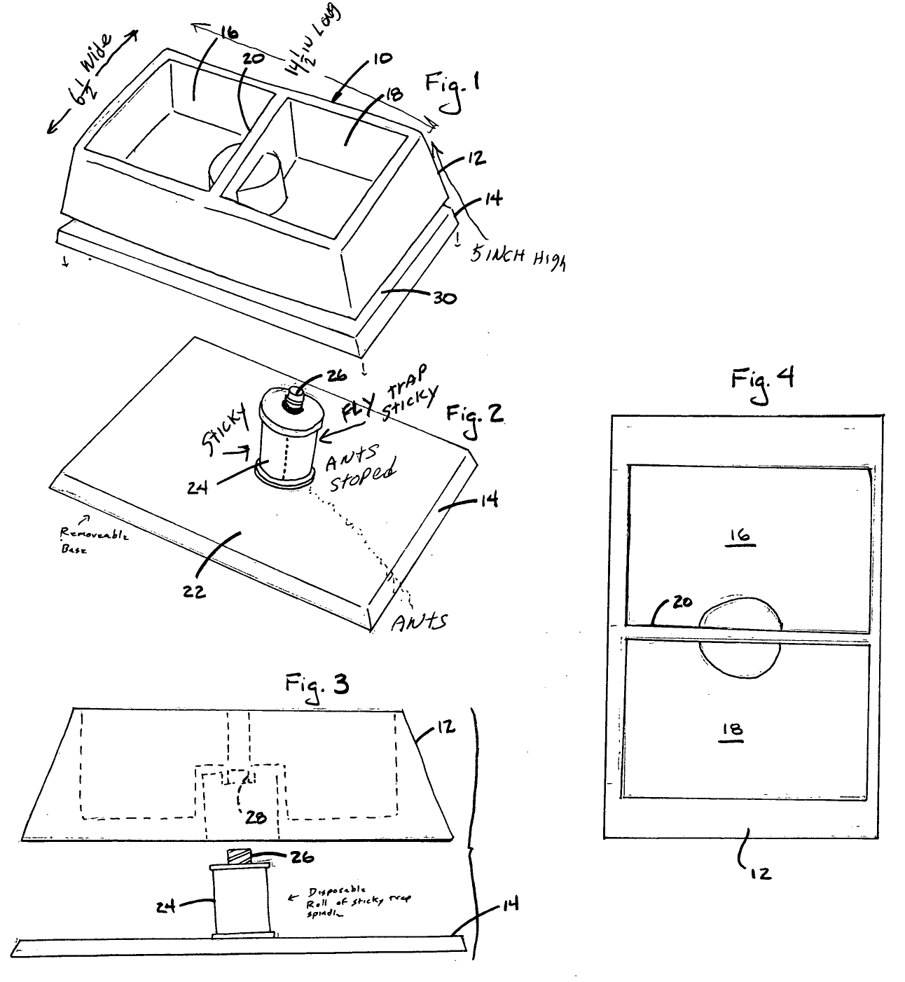

With reference to FIG. 1, a pet bowl 10 according to one embodiment of the present invention is shown having a bowl portion 12 above a base portion 14. Pet bowl 10 is shown as being generally rectangular in shape. However, it should be understood that the bowl can be of any desired shape, such as generally circular. Pet bowl 10 is also shown as having two top openings 16 and 18, separated by a cross wall 20 (see FIG. 4). This configuration allows the bowl to be used as a combination food and water bowl if desired. Alternatively, the bowl could be used with other combinations of contents such as dry food and canned food. Moreover, it should be understood that the upper portion of the bowl can be configured as a single opening, or in any other manner desired for holding particular contents.

FIG. 2 shows base portion 14 of the pet bowl separated from the upper bowl portion. Base portion 14 has a generally flat, rectangular support portion 22 that will rest on the surface on which the pet bowl is placed. The support portion is shown as generally rectangular and dimensioned so as to match with the shape and dimension of the bowl portion that will be suspended above it. However, the support portion need not match the shape and dimensions of the bowl portion. It need only be shaped and sized so as to provide adequate support for the bowl portion during use.

Attached to and extending up from the top surface of support portion 22 is a pedestal or spindle 24. Pedestal 24 is located roughly in the center of the support portion. Preferably, the pedestal is cylindrical in shape as this shape will most easily allow the bowl portion to be placed over the base portion. However, the pedestal may be conical, pyramidal, rectangular in cross section or otherwise shaped as long as it is able to support the underside of the bowl portion and hold the bowl portion above the base portion.

A sticky substance able to stop and hold most bugs or insects is applied to the sidewalls of pedestal 24. The sticky substance may be like those used in fly traps and can be coated on the sidewalls of the pedestal. Alternatively, the sticky substance may be on the outer surface of a series of successive sheets that are wrapped around the pedestal, much like that found on the rolling lint removers. In this alternative embodiment, once a number of insects or bugs have been stuck in the sticky surface, the outer sheet or layer, which is split or perforated at one point about the circumference, can be pulled off to refresh the sticky surface. The sticky surface may then be refreshed until all of the sheets or layers have been removed. At that point, a new pet bowl may be purchased or replacement rolls of sticky sheets may be made available to be placed on the pedestal and thereby renew the bowl.

At the top, center of the pedestal is an attachment mechanism 26. In the embodiment depicted, attachment mechanism 26 is a threaded extension. As shown by FIG. 3, the bowl portion has a threaded receptacle 28 on its underside adapted to receive extension 26. Thus, the upper bowl portion may be lowered down onto the base portion and turned to threadably connect the bowl portion to the base portion. The two portions may also be unthreaded from one another to separate them. Although a threaded connection is depicted, other types of releasable connections, such as snap-lock connections, may also be used.

To use the pet bowl, the bowl portion is attached to the base portion and then food and/or water is placed in the top opening or openings. The bowl may then be placed on the floor or ground for feeding a pet. The pedestal and the side wall dimensions are such that when the bowl portion is attached to the base portion there is a gap or space 30 between the two except at the point of attachment of the pedestal to the bowl portion. The gap is such that most crawling insects or bugs approaching the bowl will go under the bowl portion and encounter the sticky surface of the pedestal rather than be able to climb onto the side walls of the bowl. This will keep most insects or bugs out of the contents of the bowl.

The bowl portion may be fixedly attached to the base portion. However, in the exemplary embodiment shown, the two are separable so that the bowl portion may be separated for * cleaning, such as in a dishwasher. Access to the sticky surface to renew or replace that surface is also easier in the embodiment that is depicted. Moreover, the sticky surface is located under the bowl portion where it is protected somewhat from rain and the elements and where it is less likely that dust, dirt, lint or other materials will come in contact with the sticky surface and partially or fully cover the surface, rendering the surface less effective.

The bowl may be provided in a variety of sizes for different types and sizes of pets. It may also be made or formed from a variety of materials, such as plastics, metal or ceramics. The base portion may also be made of the same or a different material as the bowl portion. Other revisions and modifications may also be possible.

What is claimed is:

1. A pet bowl comprising:
an upper bowl portion;
a lower base portion;
a pedestal extending between and supporting the bowl portion above the base portion; and
a sticky surface on the pedestal.

2. The pet bowl of claim 1 wherein the upper bowl portion is removably attached to the pedestal.

3. The pet bowl of claim 1 wherein the upper bowl portion extends over and substantially around the sticky surface.

4. The pet bowl of claim 1 wherein there is gap between the bowl portion and the base portion except at the place where the pedestal supports the bowl portion.

5. The pet bowl of claim 1 wherein the sticky surface is renewable.

6. The pet bowl of claim 1 wherein the sticky surface is replaceable.

7. The pet bowl of claim 1 wherein the upper bowl portion is separable from the pedestal and is dishwasher safe.

8. The pet bowl of claim 2 wherein the upper bowl portion is threadably connected to the pedestal.
